(19) United States
(12) Patent Application Publication
(10) Pub. No.: US 2009/0220296 A1
(43) Pub. Date: Sep. 3, 2009

(54) Partially threaded bolt for use with a self-threading fastener and method of use

(76) Inventor: Edwin D. Bowling, JR., Busy, KY (US)

Correspondence Address: JAMES M. FRANCIS, 300 W VINE ST, STOLL KEENON OGDEN PLLC, LEXINGTON, KY, 40507, US

(21) Appl. No.: 12/039,733

(22) Filed: Feb. 28, 2008

(51) Int. Cl. F16D 1/072; F16B 37/00

(52) U.S. Cl. 403/282; 411/437

(57) ABSTRACT

A nut for use with a self-threading bolt-like fastener possessing a cavity for collecting and compacting cuttings produced by the self-threading process. The central bore of the nut is partially threaded, the threads originating at the first end of the nut and terminating between the first end and the second end, the threads having the same pitch as the self-threading fastener it is intended for use with. The self-threading bolt-like fastener has a larger diameter across the cutting threads that the diameter of the central bore of the nut.

### BACKGROUND OF THE INVENTION

1. Field of the Invention

The invention relates to a partially threaded fastener nut for use with self-threading fasteners, and more particularly to such a fastener nut which has a partially threaded cavity for use with a self-threading fastener that contains a collecting, retaining, and compacting recess for material cut by the self-threading fastener.

2. Problems in the Art

There is an unmet need to provide a bolt and nut system which has increased vibration resistance over existing products available today. Vibration heavy applications include military applications such as artillery and tanks and also includes civilian applications such as elevators, roller coasters, and mills to name a few non-limiting examples.

### SUMMARY OF THE INVENTION

According to the invention, there is provided a partially threaded fastener nut for complementary use with a self-threading fastener that can collect, retain, and compact cutting material. The nut is hardened on the hex faces and on the ends while the interior of the nut is typically unhardened but can be partially hardened or hardened to a lesser degree than the self-threading fastener.

### BRIEF DESCRIPTION OF THE DRAWINGS

FIG. 1 depicts a self threading fastener that collects cuttings in a fastener cavity and a typical hex nut.

FIG. 2 depicts a side cutaway profile of the fastener and nut of FIG. 1 demonstrating that the nut is partially threaded.

FIG. 3 depicts a view of the fastener of FIG. 1 engaged with the nut of FIG. 1.

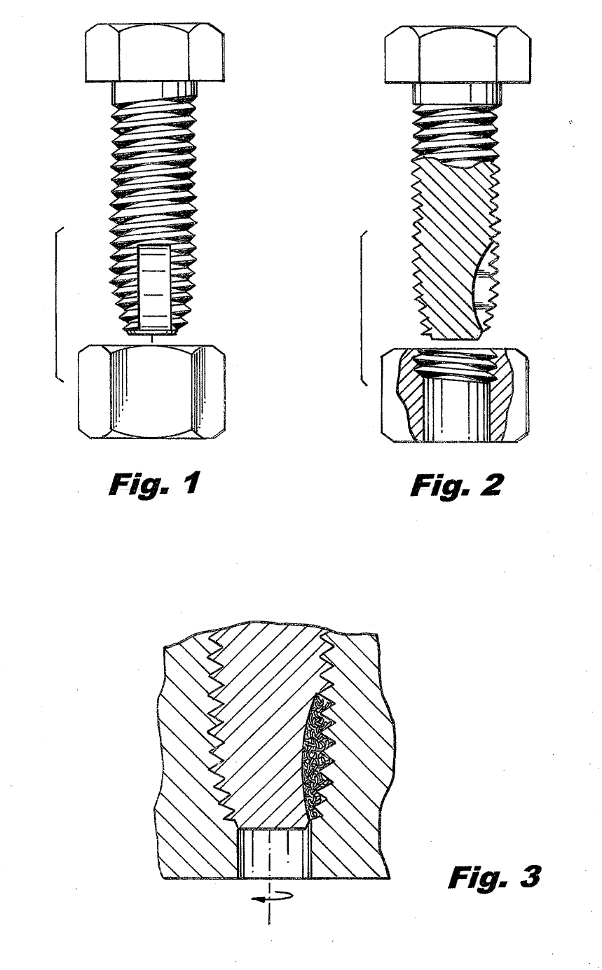

### DETAILED DESCRIPTION OF THE INVENTION

As is well known in the art, the nut 10 may be made of hardenable steel. The nut 10 is fabricated with the steel in its soft state and thereafter is heat treated. Threads 9 can be cut before or after heat treating depending on the grade of nut 10 desired. The exterior surface 5 and ends 7 of the nut 10 should have a hardness of from about Rockwell Hardness Scale C (“RHC”) 48 to about RHC 55 to a depth of from about 0.008 to about 0.012 inch. The interior surface 1 of the nut 10 should have a hardness of from about RHC 32 to about RHC 39. The hardness is determined by a micro-hardness test (ASTM E-384) performed on the layer present at 0.002 inches from the exterior surface 5.

Fundamentally, the inner surface 1 of the nut 10 should be softer (less hard) than the self-threading fastener 100. This permits the fastener 100 to cut more easily through the interior surface 1 of nut 10. Some of the material cut from the nut, the cuttings 50, by the self threading fastener 100 is retained in a cavity 101 of the self threading fastener 100 where the cuttings 50 are collected, retained and compacted.

The interior diameter 3 of the bore 4 along the unthreaded interior surface 1 of the nut 10 is slightly smaller than the fastener diameter 109 across the fastener threads 103.

The inner surface 1 of the nut 10 may also be lined with a different metal or alloy that is softer than the steel of the fastener 100 and which will form the cuttings 50 which heat weld with the threads 9 in the nut 10 cut by said fastener 100 so as to help lock the fastener 100 and nut 10 together for a more stable arrangement.

It has been found that the nut 10 can be hardened on its exterior surface 5 and ends 7 while masking the interior surface 1 of the nut 10 so as to prevent carburization during heat treatment. The interior surface 1 of the nut 10 can also be coated in copper as the masking agent which will result in the copper being available for cutting and collection by the self threading fastener 100 as it cuts its way through the nut 10 both through the copper and through the underlying steel. The use of masking agents to prevent the carburization of steel during the hardening process is well known in the art and will not be discussed in detail. CONDURSAL, available from The Duffy Company of Palatine, Ill., is ideally utilized as a masking agent because it is environmentally friendly. Other types of masking agents such as copper sulfate and petroleum based agents (to name a few non-limiting examples) can also be utilized depending on the specific needs of the metal fabricator during the hardening process.

It will be apparent from the Figures that the fastener 100 is intended to engage a leading thread 2 of the nut 10, preferably in a clockwise rotation. A counterclockwise threading is also possible.

Modifications may be made in the invention without departing from the spirit of it.

What is claimed is:

1. A nut for use with a self-threading bolt-like fastener comprising; a nut having a first end, a second end, a central bore, an inner surface and an outer surface; the interior surface being partially threaded, the threads originating at the first end of the nut and terminating between the first end and the second end, the threads having the same pitch as the self-threading fastener it is intended for use with, and said central bore having a smaller diameter across the unthreaded central bore than the diameter of the threaded length of the self-threading fastener.

2. The nut of claim 1, wherein said nut is comprised of plastic.

3. The nut of claim 1, wherein said nut is comprised of metal.

4. The nut of claim 3, wherein said nut is comprised of 4140 alloy steel.

5. The nut of claim 3, wherein said exterior surface and said ends of said self threading fastener have an exterior Rockwell scale C hardness of from about 48 to about 55 to a depth of from about 0.008 to about 0.012 inch.

6. The nut of claim 5, wherein said interior surface of said nut has a Rockwell scale C hardness of from about 32 to about 39.

7. The nut of claim 6, wherein said cuttings collected by said fastener engage said threads of said nut so as to cooperate with said bore to lock said fastener in place against the effect of vibration.

8. The nut of claim 1, wherein said nut is hexagonally shaped.

9. A method of fastening comprising; rotatingly engaging a self-threading bolt-like fastener having a cavity that collects cuttings created by the threading process with a partially threaded nut having an interior surface hardness less than that of the self-threading bolt-like fastener.

10. The method of claim 9, further comprising compacting the cutting in a cavity on a shaft of the self-threading bolt like fastener.

11. A metal nut for use with a self-threading metal bolt-like fastener that collects cuttings with a fastener cavity, said nut comprising a metal nut with a central bore having an exterior surface, a first end and a second end, an unthreaded interior surface and a partially threaded interior surface originating at said first end of said nut and terminating between said first end and said second end, the threads of said partially threaded interior surface having the same pitch as said self-threading fastener and said central bore having a smaller diameter across said unthreaded interior surface than the diameter of said fastener across said fastener threads and said wherein said exterior surface and said ends of said self threading fastener have an exterior Rockwell scale C hardness of from about 48 to about 55 to a depth of from about 0.008 to about 0.012 inch and said partially threaded interior surface and said unthreaded interior surface of said nut each have Rockwell scale C hardness of from about 32 to about 39.

12. The nut of claim 11, wherein said cuttings collected by said fastener engage said threads of said nut so as to cooperate with said bore to lock said fastener in place against the effect of vibration.
